(19) United States
(12) Patent Application Publication
(10) Pub. No.: US 2005/0026108 A1
(43) Pub. Date: Feb. 3, 2005

(54) Foot control

(75) Inventors: Wolfgang Meingassner, Uberackern (AT); Silvia Haberl-Resch, Salzburg (AT)

Correspondence Address: KLARQUIST SPARKMAN, LLP, 121 SW SALMON STREET, SUITE 1600, PORTLAND, OR, 97204, US

(73) Assignee: W&H Dentalwerk Burmoos GmbH

(21) Appl. No.: 10/898,583

(22) Filed: Jul. 23, 2004

(30) Foreign Application Priority Data
Jul. 31, 2003 (AT) A 1213/2003

(51) Int. Cl. A61C 1/02

(52) U.S. Cl. 433/101

(57) ABSTRACT

The present invention relates to a foot control for the operation of, in particular, medical and dental equipment or control devices with at least one pushbutton. In order to be able to satisfy requirements from different areas of application and users' individual wishes, the foot control provides connection between at least two pushbuttons by a web formed from the housing or from the housing and a base plate. The width of such web is at most equal to the length of the pushbutton, and may be detachably connected in the foot control. Furthermore, the axis of rotation of at least one pushbutton is disposed approximately in a position to be aligned with the extension of the axis of the lower leg of a user, and the pressing force to be applied to operate the pushbutton can be varied by means of detachable springs under the pushbutton cap, the position of which springs can be changed.

### CROSS REFERENCE TO RELATED APPLICATION

The present application claims priority from pending Austrian Patent Application No. A 1213/2003, filed Jul. 31, 2003, which is incorporated herein by reference.

### BACKGROUND OF THE INVENTION

1. Field

The present invention relates to a foot control for the operation of, in particular, medical and dental equipment and control devices with a base plate, a housing disposed thereon and at least one pushbutton for the operation of one or more control/switching element(s).

2. Description of Prior Art

With such foot controls, one or more smaller pushbuttons often are disposed laterally around a larger central pushbutton; see for prior examples EP 1 243 223 A2 (FIG. 1) and EP 789 929 B1 (FIG. 1).

A drawback to such prior devices is the low degree of flexibility that these foot controls permit users in various areas of application: in areas in which crude footwear is worn, for example for surgical intervention in the case of accidents where rubber shoes often are used for the purpose of easy disinfection, the user's tactile perception is markedly diminished, so that the operation of the smaller pushbuttons is often difficult to control and there is the risk of inadvertently stepping on several push buttons at the same time.

In certain areas of application, for example in the ear, nose and throat area, it may be sufficient for one parameter of an instrument that is currently being used, for example the speed of a drill or the speed of a saw, to be able to be changed with the foot control. Thus, in this case users may prefer a foot control with only one pushbutton. In contrast, in the area of eye surgery or implantology for example, where complex control devices enable the selection of different operating programs and the adjustment of a large number of parameters, users require foot controls by means of which as many adjustments as possible can be carried out on the control device, in order to avoid contact with the non-sterile control device and in order to have to turn away from the operating area as little as possible.

When a number of users are making use of a foot control, there often are very different personal preferences as to how many pushbuttons are to be used or as to how great the force is to be to operate the pushbuttons.

The foot controls represented in the two specifications EP '223 and EP '929 offer no possibility of meeting the various requirements and preferences of users. In order to comply with users' wishes, however, some manufacturers produce a fairly large number of different foot controls, although this gives rise to increased production and administrative costs.

The problem underlying the present invention, therefore, is the need to design an improved foot control in such a way that the operation of the foot control is more reliable and easier and, in particular, the user can independently carry out adaptations to requirements arising from different areas of application or to personal preferences in an uncomplicated manner and without expending a great deal of time.

### SUMMARY OF THE INVENTION

An aspect of the present invention is to provide a foot control that is reliable and easily used by an operator in a comfortable manner.

Another aspect of the invention is to provide a foot control that can be changed to be adapted to various requirements and applications with such changes being able to be made easily and quickly.

A foot control, according to the invention, may have a plurality of pushbuttons with a connection between the pushbuttons being comprised of a web formed from a housing. Further, a pushbutton may be detachably connected in the foot control.

As one aspect of the invention, the foot control has at least one pushbutton mounted rotatably on an axis of rotation and having a toe end and a heel end in the portion engageable by an operator's foot, and the axis of rotation is disposed nearer the heel portion than the toe portion.

With a foot control according to an embodiment of the invention, the separation of the pushbuttons by means of webs, whose width is less than the length of the pushbuttons, facilitates the tactile perception of the individual pushbuttons by the user. A clear perception of the separation is provided with pushbuttons of differing size, as long as the width of the web corresponds at most to the length of the smaller pushbutton.

The length of the pushbutton is defined as follows: if the foot control is positioned in front of the user in such a way that the latter can operate it in the prescribed manner, then each pushbutton has a side close to and distant from the user (in the case of the rectangular pushbuttons, for example) or a point closest to and most distant from the user (e.g. in the case of circular pushbuttons). The shortest connection between these two sides or points corresponds to the length of the pushbutton.

In a first embodiment, the web is much narrower than the length of the pushbutton, preferably less than half the length of the pushbutton, and may be less than a quarter the length of the pushbutton.

If the webs that connect the pushbuttons are designed asymmetrically, e.g. becoming narrower from a larger pushbutton to a smaller pushbutton, then the smallest width of the web may correspond at most to the length of the smaller pushbutton in order to guarantee that the user can adequately distinguish between the pushbuttons.

In order to make it easy for the user to find the pushbuttons, a housing surrounds the individual pushbuttons (pushbutton caps) in a further embodiment, so that an edge formed by the housing is present around each pushbutton. In order to guarantee that, in this case too, the user can adequately distinguish between the housings surrounding the pushbuttons, the features described above also apply in the same way to the housings surrounding the pushbuttons.

In a further embodiment, the pushbuttons and/or the housing sections surrounding these pushbuttons separated by webs are of differing height, so that distinguishing between the individual pushbuttons is further facilitated.

By means of the detachable connection of a pushbutton cap and/or of a part of a pushbutton housing and/or of the switching/control element and/or of the strip conductor with the foot control, the manufacturer or the user is able, depending on what he has in mind, to inactivate one or more pushbuttons so that the pushbutton does not emit a signal.

In an embodiment, the pushbutton cap alone is detachably connected with the foot control. On the side of the pushbutton cap facing the switching element, there is a part of the switching/control element, e.g. a pin, which, when force is exerted on the pushbutton, switches on a mechanical switch, or a magnet. The removal of the pushbutton cap thus prevents activation of the switch. The pushbutton cap preferably is replaced by a blind plug (cap without pin or magnet), in order to avoid penetration of impurities into the pushbutton and the switch.

In another embodiment, the pushbutton cap together with a further part of the pushbutton and of the switching/control element and/or of the strip conductor is separated from the foot control and is preferably replaced by a blind plug, which has the same shape as the pushbutton, but which lacks the removed part of the switching/control element.

In a further embodiment, the whole pushbutton including the respective housing parts and the switching/control elements contained therein and/or the strip conductors is removed, preferably also with the web, so that only active pushbuttons are available on the foot control and the user does not have to distinguish between active pushbuttons and pushbuttons rendered inactive, for example by blind plugs.

The advantage of the above described embodiments over the inactivation of one or more pushbuttons, for example by means of the software of the control device or a blocking mechanism that prevents the movement of the pushbutton cap for example, lies in the fact that it is much easier for the user to find the remaining active pushbuttons on account of the inactive keys being reduced in their height or completely removed, and an inadvertent operation of inactive pushbuttons or catching thereon is avoided in the case of removed pushbuttons or the possibility of this is reduced in the case of pushbuttons reduced in their height.

All connections known according to the prior art can be used as detachable connections, preference being given to those whose operation does not require any tools, e.g. plug-in connection, clamped connection, bayonet connection or screw connection.

In a still further embodiment, one pushbutton is designed larger than the other pushbuttons, said larger pushbutton preferably being disposed centrally, and is used for the infinitely variable control of an operating parameter (e.g. the speed), whilst the smaller pushbuttons disposed peripherally are used to select programs, to adjust operating parameters or for switching on/off additional functions (e.g. supply of a cooling medium).

Since the operating principle of the foot control, suitable switching/control elements (such as for example Hall sensors, potentiometers, mechanical pushbuttons, Reed sensors, and membrane switches) and of their mode of operation, the routing and processing of signals generated by the foot control as well as the connection to electrical and electronic switching systems of, in particular, medical and dental equipment or control devices correspond to the prior art and are known to the expert in the case of the foot control according to the invention, these will not be gone into further.

With an embodiment of the foot control, in which an axis of rotation is disposed in the portion closest to the user's heel, great ease of movement and thus a low degree of fatigue in the case of lengthy operation is achieved by the arrangement of the axis of rotation in the half of the pushbutton, preferably in the quarter of the pushbutton, that is closest to the user's heel, particularly preferably in the area of the extension of the longitudinal axis of the lower leg and beneath the user's ankle joint of the leg operating the foot control. The axis of rotation being in the area of the ankle joint of the leg is of great advantage, in particular because the axis of rotation of the foot about the leg and the axis of rotation of the pushbutton cap are thus arranged in parallel, as a result of which a maximum force transfer and lever action arises.

With another embodiment of the foot control having a detachably connected spring associated with the pushbutton cap, users can vary the force required to operate the pushbutton according to their preference and their foot size. For this purpose, the pushbutton cap may be released from the foot control in order to gain access to at least one of the springs disposed detachably thereunder, said spring serving to preload the pushbutton or to return it to its initial position.

In an embodiment, the user has several springs available with different spring forces, so that the force required to operate the pushbutton can be varied by exchanging the springs. The springs are secured by means of plug connections, for example clips, which are designed as part of the pushbutton cap and/or of the pushbutton housing and accommodate the ends of the springs.

In a further embodiment, the user can fix a detachably disposed spring in several, preferably three to five, mountings, whereby each mounting is disposed at a different distance from the axis of rotation of the pushbutton. The mountings preferably can be formed by recesses in the pushbutton housing. The farther the spring is positioned from the axis of rotation, the greater the force required to press down the pushbutton cap. According to the invention, axis of rotation is understood to mean not only an axis that is physically present, e.g. in the form of a bolt, but generally the area of the pushbutton cap that performs no angular motion or only a very slight angular motion when the pushbutton is operated. The advantage of this example of embodiment is that the user does not have to keep a set of multiple springs of various strengths.

A combination of the example embodiments can provide a particularly finely selected variation of the force required to operate the pushbutton.

### BRIEF DESCRIPTION OF THE DRAWINGS

The invention is described below with the aid of preferred examples of embodiments and by reference to the appended drawings:

FIG. 1 shows a foot control according to an embodiment of the invention in perspective view.

FIG. 2 shows a foot control according to the invention with three lateral pushbuttons in an exploded representation.

FIG. 3 shows an alternative example of embodiment of the foot control according to the invention with pushbuttons completely detachable from the foot control.

FIG. 4 shows, in a diagrammatic view, a foot control according to the invention with the axis of rotation of the pushbutton cap in the area of the extension of the heel of the user's lower leg.

Identical components are marked with the same numbers in all the figures.

### DETAILED DESCRIPTION OF THE PREFERRED EMBODIMENTS

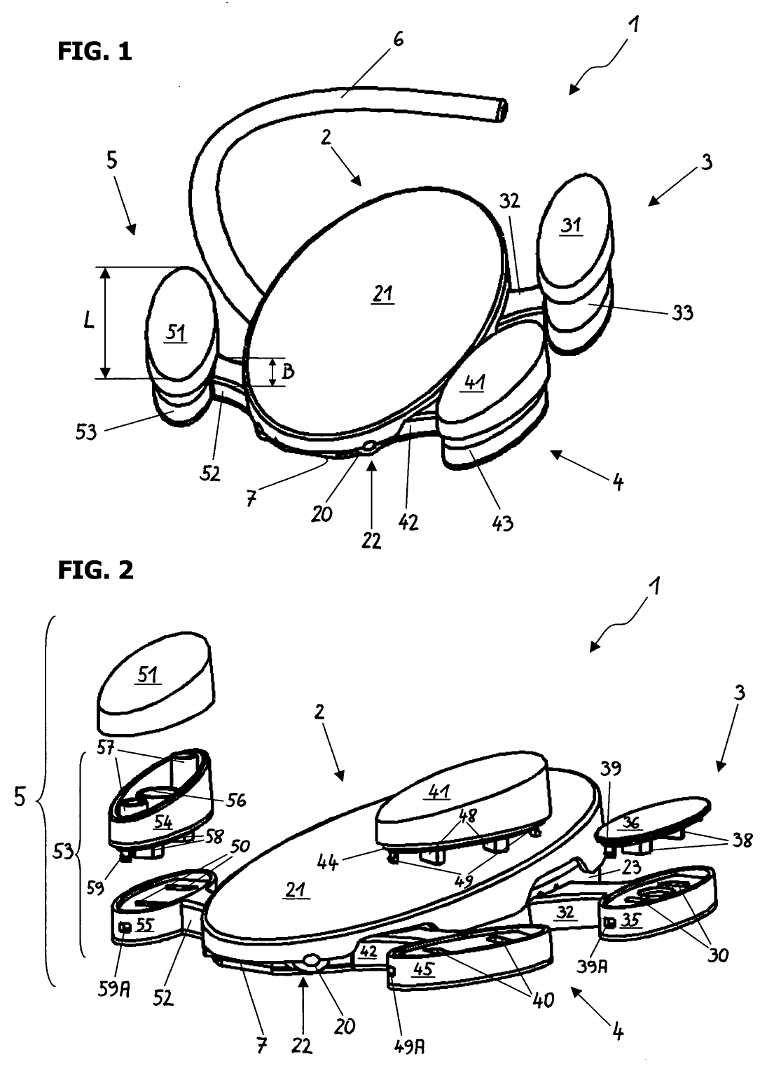

Foot control 1 illustrated in FIG. 1 has four pushbuttons 2, 3, 4 and 5, whereof pushbutton 2 is designed as a central, larger pushbutton, which is surrounded by smaller laterally disposed, peripheral pushbuttons 3, 4 and 5. Each of the four pushbuttons 2-5 comprises a pushbutton cap 21, 31, 41, 51 and a pushbutton housing 23, 33, 43, 53. Peripheral pushbuttons 3-5 are connected respectively via webs 32, 42, 52 with pushbutton housing 23 and base plate 7 (see FIG. 2) of pushbutton 2. In order to facilitate the user's perception of the individual pushbuttons, webs 32, 42, 52 are narrower than pushbuttons 3-5, their width B amounting to approximately a quarter the length L of pushbuttons 3-5. Furthermore, pushbuttons 3-5 are higher than pushbutton 2, which also makes it easier for the user to recognize and distinguish pushbuttons 3-5 from pushbutton 2.

All pushbutton housings 23, 33, 43, 53 and webs 32, 42, 52 are disposed on, or coupled to, a bottom, or base, plate 7. Bracket, or lifting handle, 6 fitted to the side of pushbutton housing 23 is used to change the location of foot control 1 in an easy and convenient manner and can be folded forward to be out of the way when foot control 1 is being operated.

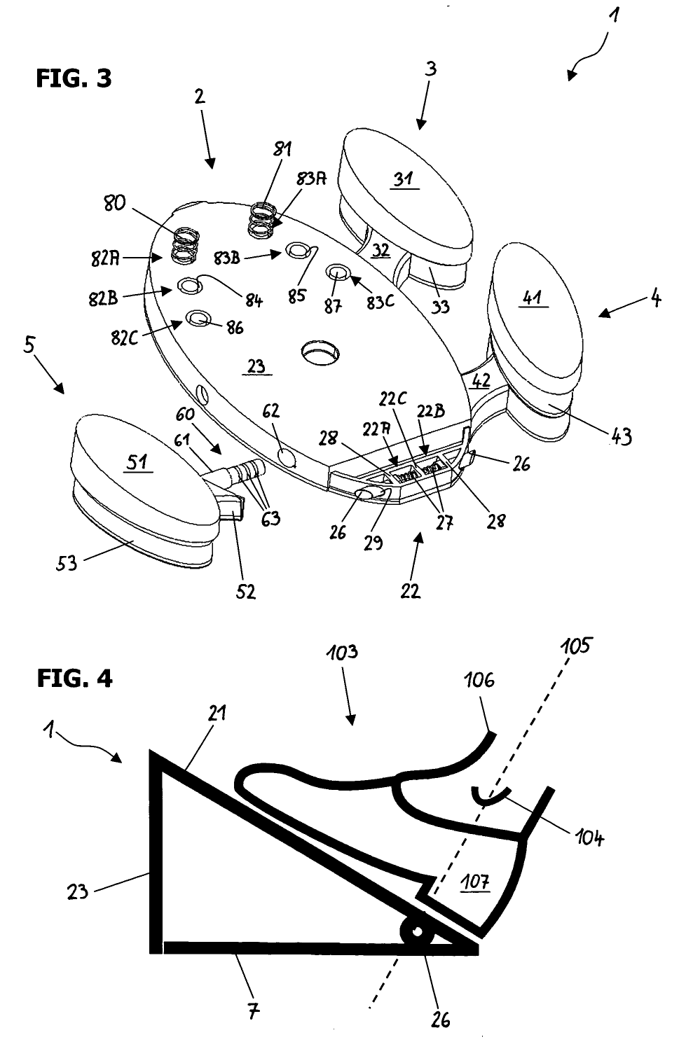

By means of a lock 22, pushbutton cap 21 can be separated from pushbutton housing 23. Lock 22 consists of two identical chambers 22A and 22B, which are separated from one another by a wall 22C and each has a guide web 28 with an opening (see FIG. 3). A pair of axially aligned elongate rods, or bolts 26 project through respective openings, in webs 28, said bolts emerging to the exterior through further openings 29 in opposite sides of pushbutton housing 23. Each bolt 26 is preloaded by springs 27 inside chambers 22A and 22B, respectively, so that its end section is at a distance from the side wall of pushbutton housing 23 such that the user can detach and fit pushbutton cap 21 in an uncomplicated manner. This takes place by pressing the two bolts 26 against the direction of action of springs 27, as a result of which the end sections of bolts 26 are displaced into chambers 22A, 22B. Pushbutton cap 21 can now be placed onto pushbutton housing 23 and bolts 26 can be released. Pushbutton cap 21 has on its sides two openings 20 (see FIG. 1), which, once pushbutton cap 21 has been placed onto pushbutton housing 23, lie over openings 29. Bolts 26 are displaced outwards by springs 27 and project through the two openings 20 and 29, as a result of which pushbutton cap 21 is fixed on housing 23. At the same time, bolts 26 also serve as a pivot connection to provide an axis of rotation for pushbutton cap 21.

As can be seen from FIG. 2, each pushbutton housing 33, 43, 53 of foot pushbuttons 3-5 consists of a pushbutton housing upper-part 44, 54 (not shown in the case of pushbutton 3) and a pushbutton housing lower-part 35, 45, 55. The detailed structure can be seen by way of example from pushbutton 5: pushbutton housing lower-part 55 is connected via web 52 with housing 23. By means of a detachable plug-in connection, consisting of openings 50 and extensions 58, as well as a detachable snap-hook connection 59, 59A, pushbutton housing upper-part 54 is fixed onto pushbutton housing lower-part 55. The shape and diameter of the two housing parts 54 and 55 are adapted to one another, so that as tight a connection as possible arises. The shape and diameter of pushbutton cap 51 are dimensioned in such a way that pushbutton cap 51 can be pushed over pushbutton housing upper-part 54. Pushbutton cap 51 and pushbutton housing upper-part 54 are fitted together via a screw connection with hollow, cylindrical mountings 57 in pushbutton housing upper-part 54, in which a spring and a screw are mounted in each case. A cone with an internal thread for accommodating the screw is located on the inside of pushbutton cap 51. The springs contained in mountings 57 urge cap 51 upwardly to preload pushbutton cap 51 against pushbutton housing upper-part 54 to a raised position. When downward force is exerted on pushbutton cap 51, there is a relative movement of pushbutton cap 51 downwardly towards pushbutton housing upper-part 54 against the force action of the springs. A switching/control element (not shown), e.g. a permanent magnet, is fitted on the inside of pushbutton cap 51. Due to the relative movement of pushbutton cap 51, the switching/control element approaches a sensor 56, e.g. a Hall sensor, in pushbutton housing upper-part 54. The Hall sensor detects the magnetic field, or more precisely the change in the strength of the magnetic field, and sends a signal via strip conductors (not shown) from pushbutton 5 via web 52 to a board in pushbutton housing 23. When the action of the force ceases, pushbutton cap 51 is moved again by the springs into its initial raised position.

On account of the multi-part structure of pushbuttons 3, 4, 5 and the detachable connections between the individual pushbutton parts, the user can, in order to inactivate one or more pushbuttons 3, 4, 5, detach pushbutton caps 31, 41, 51 and/or pushbutton housing upper-parts 44, 54 from foot control 1 and remove either the switching/control elements and/or strip conductors disposed detachably therein or preferably the whole pushbutton part (pushbutton caps 31, 41, 51, pushbutton housing upper-parts 44, 54) with the switching/control elements and/or strip conductors disposed thereon.

Pushbutton 4 in FIG. 2 represents an alternative form or embodiment: in contrast to pushbutton 5, pushbutton cap 41 and pushbutton housing upper-part 44 are connected here undetachably for the user. If the user does not require pushbutton 4, pushbutton cap 41 and pushbutton housing upper-part 44 with the switching/control element contained therein can be separated as a unit from pushbutton housing lower-part 45 to thus inactivate pushbutton 4. The connection between pushbutton housing upper-part 44 and pushbutton housing lower-part 45 is formed, as in the case of pushbutton 5, by a detachable plug-in connection 40, 48 and a detachable snap-hook connection 49, 49A. Pushbutton housing lower-part 45 remaining on pushbutton housing 23 and web 42 lie below pushbutton cap 21, as a result of which the operation of the foot control is facilitated and undesired catching or contact with inactive pushbutton 4 is avoided.

The penetration of dirt particles into pushbuttons 3, 4, 5 and thus into the whole of foot control 1 when pushbutton caps 31, 41, 51 or pushbutton housing upper-part 34, 44, 54 are removed can be avoided by fitting a blind plug, or cover, such as 36, shown by way of example on pushbutton 3 in FIG. 2. Blind plug 36 is provided with the same detachable plug-in connection 30, 38 and detachable snap-hook connection 39, 39A as pushbutton housing upper-parts 44, 54, so that the user can easily replace pushbutton cap 31 and pushbutton housing upper-part (not shown) by blind plug 36.

A further alternative embodiment is illustrated in FIG. 3: here, pushbuttons 3, 4, 5 with their respective webs 32, 42, 52 and the switching/control elements and strip conductors disposed therein can be detached from pushbutton housing 23. The connection between pushbuttons 3, 4, 5 and pushbutton housing 23 takes place via a plug-in connection 60, as is shown by way of example on pushbutton 5. Plug-in connection 60 consists of an extension 61 to web 52, in which the strip conductors for the signal routing and current supply run and end in three contacts 63. An opening 62 to accommodate extension 61 is located in the side wall of housing 23. In the assembled state, the three contacts 63 ensure the connection to the strip conductor in pushbutton housing 23. When pushbutton 5 is removed, opening 62 can again be sealed with a blind plug.

In order to be able to vary the force required to operate the pushbutton, several mountings, 82A-C for spring 80 and 83A-C for springs 81, are provided on the pushbutton housing 23. Each of these mountings 82A-C and 83A-C has a different spacing from bolt 26, which provides the axis of rotation of the pushbutton. Each mounting 82A-C and 83A-C consists of a recess such as is shown at 84, 85 and a guide pin such as shown at 86, 87 disposed therein. Springs 80, 81 are inserted detachably into recesses 84, 85 and can be moved around and into different recesses by the user as desired. Placement of the springs closer to or farther from the axis of rotation will adjust the force that a user needs to apply to operate a pushbutton. A particularly fine-stepped variation of the force required to operate pushbutton cap 21 is achieved when the user has available several springs with different spring forces, but with the same diameter, so that the latter can be inserted into selected mountings 82A-C and 83A-C.

FIG. 4 shows diagrammatically a foot control 1 according to an embodiment of the invention in a side view longitudinal section through pushbutton 2. Foot 103 of a user is positioned for operation on pushbutton cap 21. Pushbutton 21 has a heel end (at the right in FIG. 1) and a toe end (at the left in FIG. 4). As a result of the arrangement of axis of rotation 26 in the quarter of pushbutton cap 21 lying closest to the user's heel 107 (i.e. close to the heel end of the pushbutton), in particular in the extension of the longitudinal axis 105 of the lower leg 106 and beneath the user's ankle joint 104, particularly great ease of movement and thus a low degree of fatigue are achieved in the case of lengthy operation.

The invention is not restricted to the examples of embodiment presented, but includes all possible embodiments that do not change the operational principle of the invention in principle and in its general sense.

1. A foot control for operation of medical or dental equipment comprising
a base plate,
a housing disposed on said base plate,
a first pushbutton on said housing,
a second pushbutton spaced laterally of said first pushbutton and connected thereto by a web.

2. The foot control of claim 1, wherein said second pushbutton comprises a detachable pushbutton cap.

3. The foot control of claim 2, which further comprises a blind plug operable to replace the detachable pushbutton cap.

4. The foot control of claim 1, wherein said second pushbutton comprises a pushbutton cap and a housing, said pushbutton cap and said housing being detachably coupled to the remainders of said foot control.

5. The foot control of claim 4, which further comprises a blind plug operable to replace the detachable pushbutton cap and housing.

6. The foot control of claim 1, wherein said second pushbutton is detachably coupled to said first pushbutton.

7. The foot control of claim 1, wherein said second pushbutton and said web are detachably coupled to remainder portions of said foot control.

8. The foot control of claim 7, wherein said first pushbutton is adapted to be engaged by a user's foot and has opposed heel end and toe end and is mounted for pivoting about an axis of rotation which is disposed closer to said heel end than to said toe end.

9. The foot control of claim 8, wherein said axis of rotation is disposed approximately in the line of an extension of the axis of the lower leg of an operator whose foot is in operational position on said pushbutton.

10. The foot control of claim 8, wherein said first pushbutton comprises a pushbutton cap which is mounted for pivoting about an axis of rotation relative to said housing, a spring is operatively coupled to said pushbutton and housing to preload said pushbutton in one direction, and said spring is detachable and may be coupled to said pushbutton and housing at various selected distances from said axis of rotation to vary the force necessary to pivot said pushbutton.

11. The foot control of claim 10, which comprises a plurality of spaced apart spring mountings to which said spring may be coupled, and each of said spring mountings is spaced a different distance from said axis of rotation.

12. The foot control of claim 1, wherein said second pushbutton has a selected length and said web has a width which is less than half of said length.

13. The foot control of claim 1, wherein said second pushbutton has a selected length and said web has a width which is less than one quarter said length.

14. The foot control of claim 1, wherein said first pushbutton comprises a pushbutton cap, a switching element, and strip conductor.

15. The foot control of claim 1, wherein said second pushbutton comprises a housing, a pushbutton cap, a switching element and strip conductor and said second pushbutton is detachably connected to remainder portions of the foot control.

16. The foot control of claim 1, wherein one of said pushbuttons is adapted to be engaged by a user's foot and has opposed heel end and toe end and is mounted for pivoting about an axis of rotation which is disposed closer to said heel end than to said toe end.

17. The foot control of claim 16, wherein said axis of rotation is disposed approximately in the line of an extension of the axis of the lower leg of an operator whose foot is in operational position on said pushbutton.

18. The foot control of claim 1, wherein one of said pushbuttons is adapted to be engaged by a user's foot, has a selected length, opposed heel end and toe end, and is mounted for pivoting about an axis of rotation which is disposed in the quarter of said length closest to said heel end.

19. The foot control of claim 1, wherein said first pushbutton comprises a pushbutton cap which is mounted for pivoting about an axis of rotation relative to said housing, a spring is operatively coupled to said pushbutton and housing to preload said pushbutton in one direction, and said spring is detachable and may be coupled to said pushbutton and housing at various selected distances from said axis of rotation to vary the force necessary to pivot said pushbutton.

20. The foot control of claim 19, which comprises a plurality of spaced apart spring mountings to which said spring may be coupled, and each of said spring mountings is spaced a different distance from said axis of rotation.

21. A foot control for the operation of medical or dental equipment comprising
a base plate,
a first housing disposed on said base plate,
a first pushbutton on said housing including a first pushbutton cap, a first switching element, and
a first strip conductor, and
a second pushbutton including a second pushbutton cap, a second switching element, and a second strip conductor, said second pushbutton cap being detachably connected to remainder portions of said foot control.

22. The foot control of claim 21, which further comprises a blind plug operable to replace the detachable second pushbutton cap.

23. The foot control of claim 21, wherein said second pushbutton further comprises a second housing, said second pushbutton cap and said second housing being detachably coupled to the remainders of said foot control.

24. The foot control of claim 23, which further comprises a blind plug operable to replace the detachable second pushbutton cap and housing.

25. A foot control for the operation of medical or dental equipment comprising
a base plate,
a first housing disposed on said base plate,
a first pushbutton on said housing including a pushbutton cap, a switching element, and strip conductor, and
a second pushbutton including a pushbutton cap, a switching element, and strip conductor, said second pushbutton being detachably connected to remainder portions of said foot control.

26. The foot control of claim 25, wherein said second pushbutton has a selected length and is connected to said remainder portions of said foot control by a web having a width which is less than half of said length and wherein said second pushbutton and said web are detachably connected to said remainder portions of said foot control and which further comprises a blind plug operable to replace the detached second pushbutton and web.

27. A foot control for operation of medical or dental equipment comprising a pushbutton adapted to be engaged by a user's foot and having opposed heel and toe ends, said pushbutton being mounted for pivoting about an axis of rotation which is disposed closer to said heel end than to said toe end.

28. The foot control of claim 27, wherein said axis of rotation is disposed approximately in the line of an extension of the axis of the lower leg of an operator whose foot is in operational position on said pushbutton.

29. The foot control of claim 27, wherein one of said pushbuttons is adapted to be engaged by a user's foot, has a selected length, opposed heel end and toe end, and is mounted for pivoting about an axis of rotation which is disposed in the quarter of said length closest to said heel end.

30. A foot control for operation of medical or dental equipment comprising a pushbutton cap which is mounted for pivoting about an axis of rotation and a spring operatively coupled to said pushbutton cap to preload the pushbutton cap in one direction, said spring being detachable and adapted to be coupled to said pushbutton cap at various selected distances from said axis of rotation to vary the force necessary to pivot said pushbutton.

31. The foot control of claim 30, which comprises a plurality of spaced apart spring mountings to which said spring may be coupled, and each of said spring mountings is spaced a different distance from said axis of rotation.
